(19) United States
(12) Patent Application Publication
(10) Pub. No.: US 2014/0095385 A1
(43) Pub. Date: Apr. 3, 2014

(54) SELECTING MERCHANTS FOR AUTOMATIC PAYMENTS

(71) Applicants: Alex Ainslie, San Francisco, CA (US); Theodore Nicholas Choc, Palo Alto, CA (US); David Trainor, Sunnyvale, CA (US)

(72) Inventors: Alex Ainslie, San Francisco, CA (US); Theodore Nicholas Choc, Palo Alto, CA (US); David Trainor, Sunnyvale, CA (US)

(21) Appl. No.: 13/631,797

(22) Filed: Sep. 28, 2012

(51) Int. Cl. G06Q 20/40

(52) U.S. Cl. 705/44

(57) ABSTRACT

Establishing a merchant as an automatic payment recipient includes a payment system that employs a server configured for receiving a request for a first transaction with a merchant; identifying one or more transactions of the merchant; determining that the merchant is a candidate to be a payment recipient requiring a reduced authorization level; communicating a notice of the determination; receiving an indication of an acceptance of the merchant as a payment recipient requiring a reduced authorization level; establishing a reduced level of transaction authorization required for a subsequent transaction between the user and the merchant; recognizing that the user computing device is at a location of the merchant for a second transaction that is after the establishing step; and configuring the user network device to conduct the second transaction using the reduced level of transaction authorization.

### TECHNICAL FIELD

The present disclosure relates generally to contactless transactions, and more particularly to a method for establishing a merchant as an automatic payment recipient.

### BACKGROUND

Contactless payment technology incorporates proximity communications between two devices to authenticate and enable payment for goods and services over the air (OTA) or without physical connection. Near Field Communication (NFC) is an example of a proximity communication option that can enable contactless payment technologies and that is supported by the Global System for Mobile Communications (GSM) Association. RFID is an example of a proximity communication method that can be adapted to enable contactless payment technology. BLUETOOTH, wireless Internet connections, and other suitable technologies can also be adapted to enable contactless purchases.

Many conventional contactless payment applications are accessed on a mobile network device through digital wallets or other financial applications. As a result, a user must maneuver through multiple activating steps to initiate a payment transaction. For example, the mobile device must not only be turned “on” but must also be “active.” A user must unlock their mobile device and launch a contactless payment application, such as an electronic wallet application. Within the application the user must signal an intent to initiate a payment and enter security information, such as a personal identification number. The user must also select a payment option, such as a particular credit card, to use in the payment transaction. The majority of these steps must be repeated for each payment transaction.

Conventional contactless payment applications are not able to make the transactions without the need to navigate through the various authorization and activation steps. Conventional contactless payment applications are further not able to recommend merchants that would be good candidates to be an automatic payment recipient without the various authorization and activation requirements for each transaction.

### SUMMARY

One aspect of the example embodiments described herein provides a computer-implemented method to establish a merchant as an automatic payment recipient. A payment system employs a server configured for receiving, using one or more computing devices and from a user computing device associated with a user, a request for a first transaction with a merchant, the transaction request comprising information identifying an account of the user for payment of the first transaction and transaction data comprising information regarding the first transaction, the first transaction requiring a first authorization level; identifying one or more transactions of the merchant; determining that the merchant is a candidate to be a payment recipient requiring a reduced authorization level based at least in part on a comparison of the one or more transactions of the merchant with a set of parameters; communicating a notice of the determination; receiving an indication of an acceptance of the merchant as a payment recipient requiring a reduced authorization level; establishing a reduced level of transaction authorization required for a subsequent transaction between the user and the merchant, the reduced level being less than the first level; recognizing that the user computing device is at a location of the merchant for a second transaction that is after the establishing step; and configuring the user network device to conduct the second transaction using the reduced level of transaction authorization.

Another aspect of the example embodiments described herein provides a computer program product that is installed on a server located in a payment system to establish a merchant as an automatic payment recipient. The computer program product includes a non-transitory computer-readable storage device having computer-readable program instructions stored therein. The computer-readable program instructions include computer program instructions for receiving a request for a first transaction with a merchant, the transaction request comprising information identifying an account of the user for payment of the first transaction and transaction data comprising information regarding the first transaction, the first transaction requiring a first authorization level; identifying one or more transactions of the merchant; determining that the merchant is a candidate to be a payment recipient requiring a reduced authorization level based at least in part on a comparison of the one or more transactions of the merchant with a set of parameters; communicating a notice of the determination; receiving an indication of an acceptance of the merchant as a payment recipient requiring a reduced authorization level; establishing a reduced level of transaction authorization required for a subsequent transaction between the user and the merchant, the reduced level being less than the first level; recognizing that the user computing device is at a location of the merchant for a second transaction that is after the establishing step; and configuring the user network device to conduct the second transaction using the reduced level of transaction authorization.

These and other aspects, objects, features and advantages of the example embodiments will become apparent to those having ordinary skill in the art upon consideration of the following detailed description of illustrated example embodiments, which include the best mode of carrying out the invention as presently presented.

### BRIEF DESCRIPTION OF THE DRAWINGS

FIG. 1 is a block diagram depicting a system for selecting a merchant as an automatic purchase recipient, in accordance with certain example embodiments.

FIG. 2 is a block flow diagram depicting a method for selecting a merchant as an automatic purchase recipient, in accordance with certain example embodiments.

FIG. 3 is a block flow diagram depicting a method to analyze transaction details and merchant parameters to recommend a merchant for automatic payments, in accordance with certain example embodiments.

FIG. 4 is a block diagram depicting a computing machine and a module, in accordance with certain example embodiments.

### DETAILED DESCRIPTION OF THE EXAMPLE EMBODIMENTS

### Overview

In an example embodiment, a payment system includes specified information for financial accounts, including, but not limited to debit cards, credit cards, stored value cards, loyalty/rewards cards, bank accounts, stored value accounts, and coupons (including purchased offers and other offers), each accessible by a digital wallet application module. The user sets rules specifying which financial account will be used and specifying limits or circumstances during which the account will be declined. The user can then add, delete, or change the default payment rules associated with the account. The user can change these default static rules, create new rules, or delete a rule. In an example embodiment, the user can access the payment system account and modify the rules at any time, including a time immediately before a payment transaction is initiated using the proxy card. In an example embodiment, the user can access the payment system account using an application operating on a mobile device or other device equipped with a web browser and connected to the Internet.

The user can configure the payment system account to conduct transactions with merchants when the merchant is communicated with a mobile network device via a contactless technology such as near field communication (“NFC”), BLUETOOTH, Wi-Fi, RFID, or other suitable technology.

A traditional contactless transaction between a user device and a merchant or other recipient may require multiple levels of authorization and authentication. For example, the mobile device must not only be turned “on” but must also be “active.” A user must unlock their mobile device and launch a contactless payment application, such as an electronic wallet application. Within the application the user must signal an intent to initiate a payment and enter security information such as a personal identification number. The user must also select a payment option, such as a particular credit card, to use in the payment transaction. The majority of these steps must be repeated for each payment transaction.

In an example embodiment, the payment system can recommend a merchant as a trusted merchant and allow the user to process transactions with the trusted merchant without navigating some or all of the authorization levels.

The user can enter a merchant location with a user network device. The user can select an item for purchase and approach a point of sale (“POS”) terminal to conduct the transaction. The user can open the payment application on a digital wallet application module on the user device. The user device can use a communication application to establish a contactless communication with the merchant POS terminal.

The payment application can determine the identity of the merchant and determine if the merchant is configured as a trusted merchant and thus qualifies for automatic payment. If the merchant is not currently an automatic payment recipient then the payment system can determine if the merchant meets the parameters to become an automatic payment recipient.

To determine if the merchant meets the parameters to become an automatic payment recipient, the payment system can access the merchant identification, transaction history with the user and other users, and any special parameters specified by the user.

The payment system can analyze the previous transactions between the user and the merchant. The payment system can determine the frequency and values of the transactions. The payment system can determine if the total number of transactions in a given period of time exceed a configured threshold. The threshold can be configured by the user, by a payment system operator, by the payment system based on user history, or any other suitable party.

For example, the threshold may be one visit per month over the period of one year. After the number of transactions reaches 12 transactions in one year, then the threshold will have been exceeded. The threshold may be any reasonable value and may be for a predetermined time period or may be a total number of visits regardless of the elapsed time period. For example, the threshold may be 5 total visits, 10 total visits, 12 visits per year, or any other suitable threshold.

In an example embodiment, if the transaction threshold has been met, the payment system will analyze the value of the transactions. The user or the payment system may configure a threshold value for the transactions. For example, the payment system can average the transactions and determine if the average is below a threshold or in a predetermined range of values. In another example, the payment system can take the median value and determine if the value is below a threshold. In another example, the payment system can determine if a certain percentage of the transactions are below a threshold.

The user and the payment system may desire to know if the values are below a threshold because the user may not desire to skip authorization levels on high value transactions. For example, if the user conducts many $5 transactions at a coffee shop, then the user may prefer to skip the authorization for future transactions at the coffee shop. If the user conducts many $200 transactions at an office supply store, the user may not desire to skip the authorization for future transactions at the office supply store.

If the number of transactions and the value of the transactions meet or exceed the thresholds, the merchant can be identified as an automatic payment candidate. If the merchant fails to meet either or both of the thresholds, then the merchant can be analyzed by the payment system to determine if the merchant meets other parameters to qualify as an automatic payment recipient.

The analysis by the payment system can identify a merchant as a trusted merchant and a good candidate for automatic payment status with many or all users. The payment system can identify the merchant as an automatic payment candidate for the user. An example of a merchant identified by the payment system as a trusted merchant would be a merchant that is a partner or other trusted associate of the payment system. Another example may be a merchant that fits the category of many other trusted merchants, such as a national restaurant chain or a common convenience store or other merchant that is similar to other trusted merchants. Another example may be a merchant with a proven level of trustworthiness as evidenced by a long history of successful transactions, a stable financial situation, or other evidence.

If the merchant is not identified as an automatic trusted merchant, the payment system can analyze the transaction history of the merchant. The payment system can identify merchants who conduct many transactions with multiple users for values that meet the preferred parameters. For example, if 100 users make 5 transactions per week at a merchant and the value of the transactions are between $5 and $20, then the merchant may fit the preferred parameters for an automatic payment recipient. Any suitable thresholds or ranges for the number of users, transactions per user, and transaction values may be used to predict which merchants may be automatic payment recipients. The user can further modify the parameters to allow the payment system to recommend merchants to the user that fit the preferences of the user.

The payment system can additionally or alternatively determine how many other users have accepted the merchant as a trusted merchant and allowed automatic payments. The payment system, the user, or others can establish a threshold number of users that must have accepted the merchant as an automatic payment recipient before the merchant is identified as a candidate. For example, 20, 100, or 1000 other users accepting the merchant as an automatic payment recipient can be set as the threshold that a merchant needs to exceed to be identified as a candidate.

The payment system can additionally or alternatively determine that a merchant is located in a zone or region frequented by the user. For example, if a user shops frequently in a particular shopping center, then the payment system can identify all the merchants in the shopping center as candidates to become an automatic payment recipient. The payment system can select a shopping center or zone that has the highest number of user transactions or the payment system can identify shopping centers or zones that exceed a threshold of transactions with the user.

If the merchant meets any of the criteria to be an automatic payment candidate, the merchant is identified by the payment system as an automatic payment candidate. The payment system can communicate an instruction to the payment application that the merchant is a candidate.

The payment application can offer the user the option to select the merchant as an automatic payment recipient. The payment application can offer the option via a user interface presented on the payment application. Additionally or alternatively, the option can be presented to the user via email, text, via a website of the payment system, or via any suitable method of presentation. The option can be a recommendation to the user that the merchant might be a candidate, a link to a webpage of recommendations or any suitable communication.

If the user declines the merchant as an automatic payment recipient, by ignoring the option or selecting an option to decline the recommendation, the method ends. The payment application can alternatively make the request again after a certain amount of time has elapsed or a certain number of transactions have occurred.

If the user selects the merchant as an automatic payment recipient, the payment application can offer the user the opportunity to select the automatic payment parameters. The parameters can be configured to allow certain types of transactions to be automatic while still requiring one or more levels of authorization for other transactions. The user may specify that only transactions under a specific value may be conducted with automatic payments. For example, only transactions under $10 or $20 may be conducted with automatic payments. Transactions over the configured amount may require a sign in, transaction authorization, or other authorization. The user may also specify that only a particular location of the merchant may qualify for automatic transactions or only locations within a predetermined range.

The functionality of the example embodiments will be explained in more detail in the following description, read in conjunction with the figures illustrating the program flow.

### Example System Architectures

Turning now to the drawings, in which like numerals represent like (but not necessarily identical) elements throughout the figures, example embodiments are described in detail.

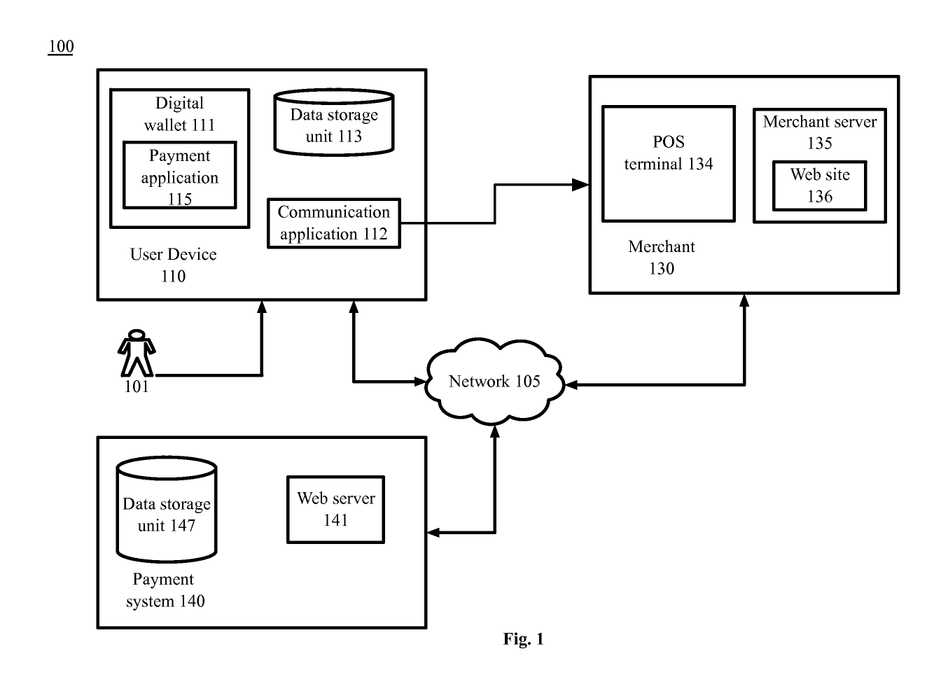

FIG. 1 is a block diagram depicting a system for establishing a merchant as an automatic payment recipient, in accordance with certain example embodiments. As depicted in FIG. 1, the system 100 includes network devices 110, 130, and 140 that are configured to communicate with one another via one or more networks 105.

Each network 105 includes a wired or wireless telecommunication means by which network devices (including devices 110, 130, and 140) can exchange data. For example, each network 105 can include a local area network (“LAN”), a wide area network (“WAN”), an intranet, an Internet, a mobile telephone network, or any combination thereof. Throughout the discussion of example embodiments, it should be understood that the terms “data” and “information” are used interchangeably herein to refer to text, images, audio, video, or any other form of information that can exist in a computer-based environment.

Each network device 110, 130, and 140 includes a device having a communication module capable of transmitting and receiving data over the network 105. For example, each network device 110, 130, and 140 can include a server, desktop computer, laptop computer, tablet computer, smart phone, handheld computer, personal digital assistant (“PDA”), or any other wired or wireless, processor-driven device. In the example embodiment depicted in FIG. 1, the network devices 110, 130, and 140 are operated by end-users or consumers, merchant operators, and payment system operators, respectively.

The user 101 can use the communication application 112, which may be, for example, a web browser application or a stand-alone application, to view, download, upload, or otherwise access documents or web pages via a distributed network 105. The network 105 includes a wired or wireless telecommunication system or device by which network devices (including devices 110, 130, and 140) can exchange data. For example, the network 105 can include a local area network (“LAN”), a wide area network (“WAN”), an intranet, an Internet, storage area network (SAN), personal area network (PAN), a metropolitan area network (MAN), a wireless local area network (WLAN), a virtual private network (VPN), a cellular or other mobile communication network, Bluetooth, NFC, or any combination thereof or any other appropriate architecture or system that facilitates the communication of signals, data, and/or messages.

The communication application 112 can interact with web servers or other computing devices connected to the network 105, including the point of sale terminal 134 of the merchant system 130, the merchant server 135 of the merchant system 130, and the web server 141 of the payment system 140.

The user network device 110 may include a digital wallet application module 111. The digital wallet application module 111 may encompass any application, hardware, software, or process the user device 110 may employ to assist the user 101 in completing a purchase. The digital wallet application module 111 can interact with the communication application 112 or can be embodied as a companion application of the communication application 112. As a companion application, the digital wallet application module 111 executes within the communication application 112. That is, the digital wallet application module 111 may be an application program embedded in the communication application 112.

The user device 110 can include a payment application 115. The payment application 115 can interact with the communication application 112 or be embodied as a companion application of the communication application 112 and execute within the communication application 112. The payment application 115 may further be embodied as a companion application of the digital wallet application module 111 and execute within the digital wallet application module 111. The payment application 115 may employ a software interface for configuration that may open in the digital wallet application module 111 or may open in the web browser application 112. Alternatively, the payment application 115 may execute on the user device 110 independent of the digital wallet application module 111 and the communication application 112.

The payment application 115 is operable to allow a user 101 to configure a payment account on the user device 110 and the payment system 140. The payment application 115 can allow the user 101 to make payments to a merchant, select automatic payment merchants, configure user accounts, and provide other suitable services.

The user device 110 also includes a data storage unit 113 accessible by the digital wallet application module 111, the payment application 115, and the communication application 112. The example data storage unit 113 can include one or more tangible computer-readable storage devices. The data storage unit 113 can be stored on the user device 110 or can be logically coupled to the user device 110. For example, the data storage unit 113 can include on-board flash memory and/or one or more removable memory cards or removable flash memory.

The user 101 may use the user device 110 or other network device to register the payment application 115 and/or access the payment system account of the user 101. The user device 110 may comprise appropriate technology that includes or is coupled to a web server (for example, Google Chrome, Microsoft Internet Explorer, Netscape, Safari, Firefox, or other suitable application for interacting with web page files).

The payment system 140 includes a data storage unit 147 accessible by the web server 141. The example data storage unit 147 can include one or more tangible computer-readable storage devices. The payment system 140 is operable to conduct contactless payments between a user 101 and a merchant system 130. The payment system 140 is further operable to maintain a database to store transactions of the merchant system 130 and the user 101, recommend automatic payment recipients, and other suitable functions.

The user 101 can use a web server 141 on the payment system 140 to view, register, download, upload, or otherwise access the payment system 140 via a website (not illustrated) and a communication network 105). The user 101 associates one or more registered financial card accounts, including bank account debit cards, credit cards, gift cards, loyalty cards, coupons, offers, prepaid offers, store rewards cards, or other type of financial account that can be used to make a purchase or redeem value-added services with a payment account of the user 101. The payment system 140 also may function as the issuer for the associated financial account. The user's 101 registration information is saved in the payment system's 140 data storage unit 147 and is accessible the by web server 144.

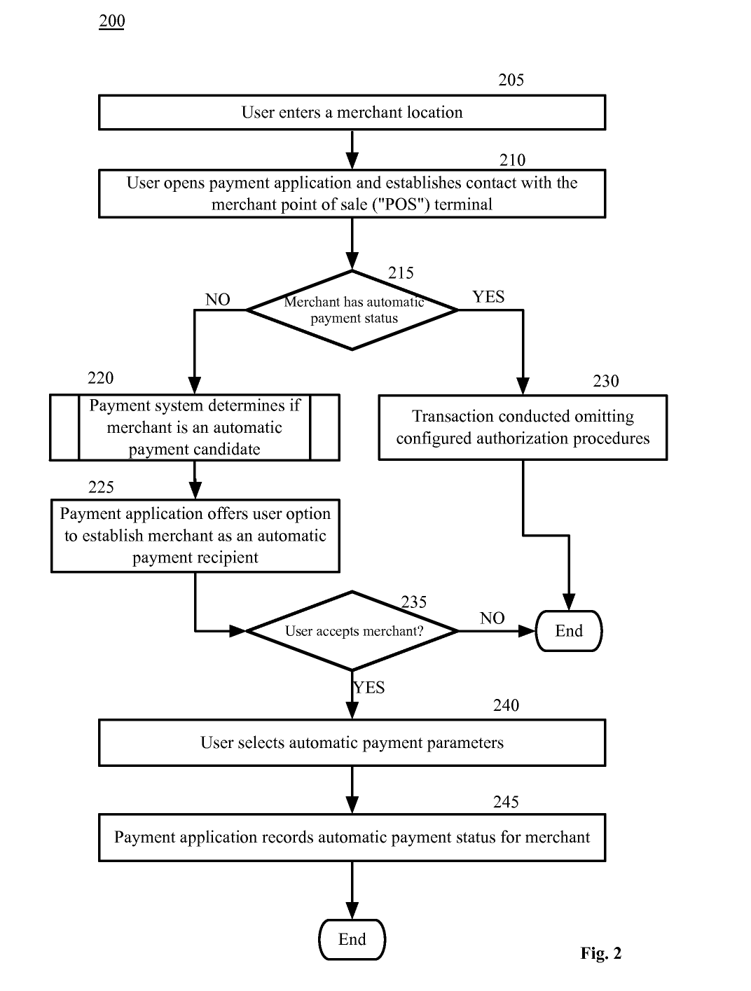

The user 101 also may use the web server 141 to define payment rules. The creation of automatic payment merchants is discussed in more detail hereinafter with reference to the methods described in FIG. 2.

The merchant system 130 may use a web server 135 to view, download, upload, create offers, sell products online, or otherwise access the payment system 140 via a website 136 and a communication network 105. The merchant system 130 represents an entity that offers products for the user 101 to purchase or use. The merchant system 130 includes a POS terminal 134. The POS terminal 134 may be operated by a salesperson that enters the purchase data into the POS terminal 134 to complete the purchase transaction. The merchant system 130 may be a physical location or an online merchant.

The user 101 may request a purchase from the merchant system 130. In an example embodiment, the purchase is initiated by a wireless “tap” of the mobile device 110 with the POS terminal 134. In an alternative example embodiment, the purchase is initiated when the user 101 enters an account identification number at the POS terminal 134 or in the mobile device 110. In another alternative example embodiment, the purchase is initiated online with the merchant server 135. The purchase may be initiated via the merchant website 136. In yet another alternative example embodiment, the purchase is initiated by use of a permanent/temporary virtual/physical token, QR code, bar code, or other suitable machine-readable medium captured by the POS terminal 134. The merchant's POS terminal 134 interacts with an acquirer (for example Chase PaymentTech, or other third party payment processing companies), the card network (for example VISA, MasterCard, American Express, Discover or other card processing networks), the payment system 140, and the issuer (for example Citibank, CapitalOne, Bank of America, and other financial institutions to authorize payment).

### Example Processes

The components of the example operating environment 100 are described hereinafter with reference to the example methods illustrated in FIG. 2.

FIG. 2 is a block flow diagram depicting a method 200 to register a user proxy card, in accordance with certain example embodiments.

With reference to FIGS. 1 and 2, in block 205, a user 101 enters the location of a merchant system 130. The merchant can be embodied as a physical location of the merchant system 130. In an alternate example, the merchant system 130 can be an online merchant system 130. The user 101 can select an item for purchase and approach a point of sale (“POS”) terminal 134 to conduct the transaction.

In block 210, the user 101 opens the payment application 140 on a user device 110. The payment application 115 is associated with a user account on a payment system 140. In an example embodiment, a payment system 140 includes specified information for financial accounts, including, but not limited to debit cards, credit cards, stored value cards, loyalty/rewards cards, bank accounts, stored value accounts, and coupons (including purchased offers and other offers), each accessible by digital wallet application module 111. The user 101 sets rules specifying which financial account will be used and specifying limits or circumstances during which the account will be declined. The user 101 can then add, delete, or change the default payment rules associated with the account. The user 101 can change these default static rules, create new rules, or delete a rule. In an example embodiment, the user 101 can access the payment system account and modify the rules at any time, including a time immediately before a payment transaction is initiated. In an example embodiment, the user 101 can access the payment system account using the payment application 115 operating on a user device 110 or other device equipped with a web browser and connected to the Internet.

The user can configure the payment system account to conduct transactions with merchants 130 when the merchant system 130 is communicating with the user device 110 via a contactless technology such as near field communication (“NFC”), BLUETOOTH, Wi-Fi, RFID, or other suitable technology.

When the payment application 115 on the user device 110 is initiated, the communication application 112 establishes communication with the POS terminal 134 of the merchant system 130. The payment application 115 can establish a communication automatically when the user device 110 is activated, when the payment application 115 is accessed, when the user 101 “taps” the user device 110 to the POS terminal 134. The tap may be any suitable motion or action by the user 101 to initiate the communication. For example, the user 101 can wave the user device 110 near the POS terminal 134, touch the user device 110 to the POS terminal 134, provide a voice activation, actuate a real or virtual button, or perform any other suitable action to initiate a communication.

If a user 101 is attempting a purchase, a contactless transaction between a user device 110 and a merchant system 130 or other recipient may require multiple levels of authorization and authentication. For example, the user device 110 must not only be turned “on” but must also be “active.” A user 101 may be required to unlock their user device 110 and launch the payment application 115. Within the payment application 115 the user 101 may be required to signal an intent to initiate a payment and enter security information such as a personal identification number. The user 101 may also be required to select a payment option, such as a particular credit card, to use in the payment transaction. The majority of these steps must be repeated for each payment transaction.

In block 215, the payment application 115 determines if the merchant system 130 is established as an automatic payment recipient. If the merchant system 130 is established as an automatic payment recipient, the method 200 follows the “YES” branch of block 215 to block 230. If the merchant is not established as an automatic payment recipient, the method 200 follows the “NO” branch of block 215 to block 220.

Following the “YES” branch of block 215 to block 230, the transaction is conducted with one or more of the initiation and authorization steps omitted based on the configuration of the automatic payments for the associated merchant system 130. For example, the payment application 115 can bypass the requirement to enter a personal identification number (“PIN”) to activate the payment application 115 if the payment application 115 recognizes the POS terminal 134 of the merchant system 130. In another example, the payment application 115 can bypass the need for the user 101 to confirm the transaction details. In another example, the payment application can bypass the need to swipe or “tap” the user device 110 near the POS terminal 134. In another example, the user device 110 may not be required to be manually activated for the transaction to take place. Any other activation, authentication procedure, or security procedure may be omitted based on the configuration of the payment application 115 and the capabilities of the payment application 115 and the user device 110.

Following block 230, the transaction is completed and the method ends.

Following the “NO” branch of block 215 to block 220, the payment application 115 determines if the merchant system 130 is an automatic payment candidate.

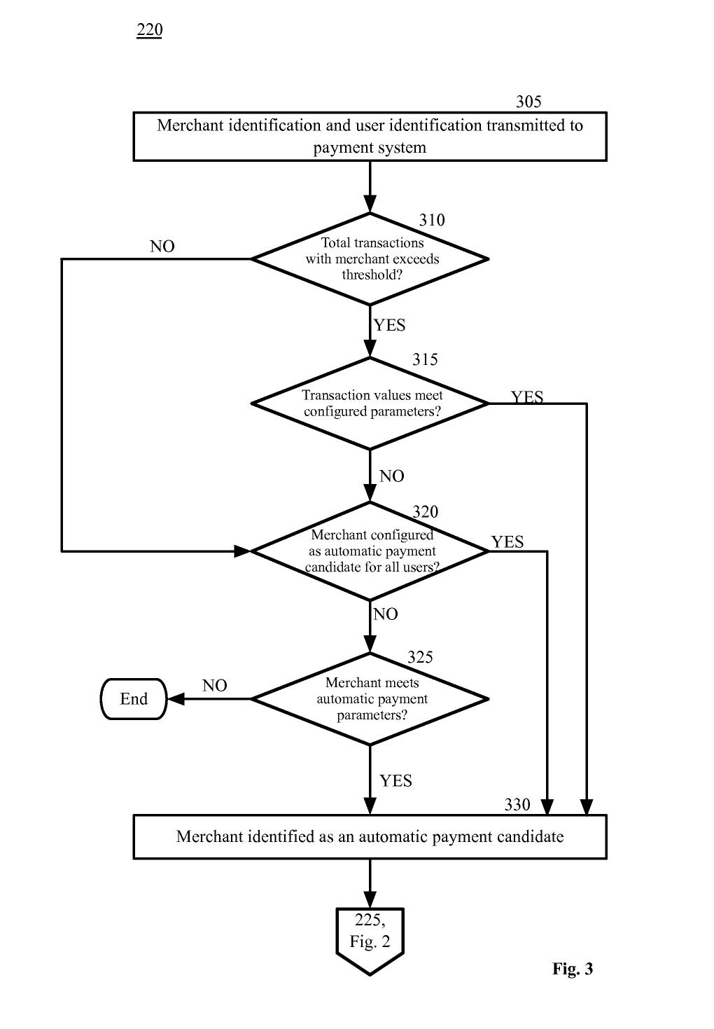

The details of an example process to determine if the merchant system 130 is an automatic payment candidate are discussed in method 220 in FIG. 3.

FIG. 3 is a block flow diagram depicting a method to analyze transaction details and merchant parameters to recommend a merchant system 130 for automatic payments, in accordance with certain example embodiments.

In block 305, the payment application 115 can transmit the identification of the merchant system 130, the identification of the user 101, and the transaction details to the payment system 140. The payment application 115 can gather the identification of the merchant system 130 from the POS terminal 134, from the location of the user device 110 and the merchant system 130, from an input of the user 101, or from any other suitable source.

On the web server 141 or on another computing system, the payment system 140 can access data and information regarding the user 101 and the merchant system 130. The payment system 140 can maintain a database of transactions, settings, and other data from the user 101 and the merchant system 130.

In block 310, the payment system 140 can determine the total number of transactions the user 101 has conducted with the merchant system 130. The payment system 140 can use the total number of transactions that have been conducted with the payment system 140 for a configured period of time, such as in the previous month, the previous year, or any other length of time.

The payment system 140 can determine if the total number of transactions in the given period of time exceed a configured threshold. The threshold can be configured by the user 101, by a payment system operator, by the payment system 140 based on user history, or by any other suitable party.

In an example, the threshold may be 1 visit per month over the period of 1 year. After the number of transactions reaches 12 transactions in one year, then the threshold will have been exceeded. The threshold may be any reasonable value and may be for a predetermined time period or may be a total number of visits regardless of the elapsed time period. For example, the threshold may be 5 total visits, 10 total visits, 12 visits per year, or any other suitable threshold.

If the number of transactions exceeds the threshold, the method 220 follows the “YES” branch of block 310 to block 315. If the number of transactions does not exceed the threshold, the method 220 follows the “NO” branch of block 310 to block 320.

Following the “YES” branch of clock 310 to block 315, the payment system 140 determines if the transaction values meet the configured parameters. The payment system 140 can analyze the values of the transactions identified in block 310.

The user 101, the payment system 140, or other suitable party may configure a threshold value for the transactions. For example, the payment system 140 can average the transactions and determine if the average is below a threshold or in a predetermined range of values. In another example, the payment system can take the median value and determine if the value is below a threshold. In another example, the payment system can determine if a certain percentage of the transactions are below a threshold.

The user 101 and the payment system 140 can analyze the transaction values to determine if the values are below a threshold because the user 101 may not desire to skip authorization levels on high value transactions. For example, if the user 101 conducts many $5 transactions at a coffee shop, then the user 101 may prefer to skip the authorization for future transactions at the coffee shop. If the user 101 conducts many $200 transactions at an office supply store, the user 101 may not desire to skip the authorization for future transactions at the office supply store.

If the value of the transactions meets the value parameters, the method 220 follows the “YES” branch of block 315 to block 330. If the value of the transactions does not meet the value parameters, the method 220 follows the “NO” branch of block 315 to block 320.

Following the “NO” branches of block 310 and block 315 to block 320, the payment system 140 can determine if the merchant system 130 is configured by the payment system 140 as an automatic payment candidate for all users. If the merchant system 130 is configured by the payment system 140 as an automatic payment candidate for all users, then the payment system 140 can identify the merchant system 130 as an automatic payment candidate for the user 101. An example of a merchant system 130 identified by the payment system 140 as a merchant system 130 that is an automatic payment candidate for all users would be a merchant system 130 that is a partner or other trusted associate of the payment system 140. Another example may be a merchant system 130 that fits the category of many other trusted merchants, such as a national restaurant chain or a common convenience store or other merchant system 130 that is similar to other automatic payment merchants 130. Another example may be a merchant system 130 with a proven level of trustworthiness as evidenced by a long history of successful transactions, a stable financial situation, or other suitable evidence.

If the merchant system 130 is configured by the payment system 140 as an automatic payment candidate for all users, the method 220 follows the “YES” branch of block 320 to block 330. If the merchant system 130 is not configured by the payment system 140 as an automatic payment candidate for all users, the method 220 follows the “NO” branch of block 320 to block 325.

Following the “NO” branch of block 320 to block 325, the payment system 140 can determine if the merchant system 130 meets a set of parameters established to identify automatic payment candidates. The payment system 140 can analyze the transaction history of the merchant system 130. The payment system 140 can identify merchants 130 who conduct many transactions with multiple users for values that meet the preferred parameters. For example, if 100 users make 5 transactions per week at a merchant system 130 and the value of the transactions are typically between $5 and $20, then the merchant may fit the preferred parameters for an automatic payment merchant system 130. Any suitable thresholds or ranges for the number of users, transactions per user, and transaction values may be used to predict which merchants 130 may be automatic payment candidates. The user 101 can further configure the parameters to allow the payment system 140 to recommend merchants 130 to the user 101 that fit the preferences of the user 101.

The payment system 140 can additionally or alternatively determine how many other users 101 have accepted the merchant 130 as an automatic payment recipient. The payment system 140, the user 101, or other suitable parties can establish a threshold number of users 101 that must have accepted the merchant 130 as an automatic payment recipient before the merchant system 130 is identified as a candidate. For example, 20, 100, 1000, or any other suitable quantity of other users 101 accepting the merchant system 130 as an automatic payment recipient can be set as the threshold that a merchant system 130 needs to exceed to be identified as a candidate.

The payment system 140 can additionally or alternatively determine that a merchant system 130 is located in a zone or region frequented by the user 101. For example, if a user 101 shops frequently in a particular shopping center, then the payment system 140 can identify all the merchants 130 in the shopping center as candidates to become an automatic payment merchant system 130. The payment system 140 can select a shopping center or zone that has the highest number of user transactions, the user 101 can identify local shopping centers or zones, or any other suitable method of selecting zones can be employed.

If the merchant system 130 meets any of the criteria to be an automatic payment merchant system 130, the method 220 follows the “YES” branch of block 325 to block 330. If the merchant system 130 does not meet any of the criteria to be an automatic payment recipient, the method 220 ends.

Following the “YES” branches of block 315, block 320, and block 325 to block 330, the merchant system 130 is identified as an automatic payment candidate. The payment system 140 can communicate an instruction to the payment application 115 that the merchant system 130 is a candidate. The merchant system 130 can be identified as an automatic payment candidate in the database in the payment system 140.

If the user 101 does not elect to make the merchant system 130 an automatic payment merchant system 130, the payment system 140 can continue to monitor the transactions of the merchant system 130 and recommend the merchant system 130 as an automatic payment merchant system 130 at a time in the future. For example, if the merchant system 130 continues to meet the automatic payment parameters, then the payment system 140 can recommend the merchant system 130 to the user 101 after every 10 transaction with the user 101. In another example, the payment system 140 can decrease the frequency of the recommendations every time the user 101 declines the merchant system 130. For example, the payment system 140 can recommend the merchant system 130 after 10 transactions, and then again after 20 additional transactions, and then again after 50 transactions. If the user 101 has not accepted the merchant system 130 as an automatic payment merchant system 130 after a predetermined number of opportunities, such as 3 or 10 opportunities, then the payment system 140 can stop recommending the merchant system 130.

From block 330, the method 220 returns to block 225 in FIG. 2.

Returning to block 225 in FIG. 2, the payment application 115 receives the indication from the payment system 140 that the merchant system 130 is a candidate for automatic payments. The payment application 115 offers to the user 101 an option to establish the merchant system 130 as an automatic payment recipient.

The payment application 115 can present the offer to the user 101 on the user interface of the payment application 115. The user interface can offer the option to the user 101 with a button or other option to accept the merchant system 130 and a button or other option to decline. Additionally or alternatively, the option can be presented to the user 101 via email, text, on a website of the payment system 140, or any suitable method of presentation. The option can be a recommendation to the user 101 that the merchant might be a candidate, a link to a webpage of recommendations or any suitable communication.

In block 235 the user 101 can accept or decline the recommendation of the merchant system 130 as an automatic payment recipient. The user 101 can accept the merchant system 130 by actuating a physical or virtual button, responding to an email or text, navigating to a web page of the payment system 140 to make the acceptance, or performing any other action indicating an acceptance. The user 101 can decline the merchant system 130 by actuating a physical or virtual button, responding to an email or text, navigating to a web page of the payment system 140 to decline the option, or performing any other action indicating that the user 101 declines the option. Additionally or alternatively, the user 101 can decline the option by ignoring the recommendation and taking no action. The payment system 140 can take no response for a predetermined amount of time as evidence that the user 101 is declining the option.

If the user 101 accepts the recommendation of the merchant system 130 as an automatic payment recipient, then the method 200 follows the “YES” branch of block 235 to block 240. If the user 101 declines the recommendation of the merchant system 130 as an automatic payment recipient, then the method 200 follows the “NO” branch of block 235 to the end of the method 200.

Following the “YES” branch of block 235 to block 240 the user 101 selects the parameters or rules for conducting automatic payments with the merchant system 130. The parameters can be configured to allow certain types of transactions to be automatic while still requiring one or more levels of authorization for other transactions. The parameters can be configured by the user 101 on the user interface of the payment application 115, on a website of the payment system 140, via email, or by any suitable manner.

The user 101 can specify that only transactions under a predetermined value may be conducted with automatic payments. For example, only transactions under $10, $20 or other suitable value may be conducted with automatic payments. Transactions over the configured amount may require one or more of a sign in, transaction authorization, or other authorization. The user 101 may also specify that only a particular location of the merchant system 130 may qualify for automatic transactions or only locations within a predetermined range. The user 101 can specify that only transactions for certain products can be conducted with automatic payments. For example, at a gas station, only transactions for gas may be made with automatic payments. Purchases at the gas station for food, alcohol, or other items may require one or more of a sign in, transaction authorization, or other authorization. Any other suitable parameters or rules may be configured by the user 101.

Additionally or alternatively, the user 101 may configure the payment application 115 to require the user 101 to confirm the automatic payment status of the merchant system 130 periodically, such as every month, every 20 transactions, or any suitable period. The payment application 115 can require the user 101 to sign in to confirm the status, provide a PIN, or require any suitable confirmation authorization.

After configuring the rules and conditions for automatic payments at a merchant system 130, the user 101 can visit the location of a merchant system 130 to conduct a transaction. The user device 110 can recognize that the user 101 and the user device 110 are at the location of the merchant system 130 through any suitable method. In one example, the user device 110 can use the global positioning system capabilities of the user device 110 or other location service accessible with the user device 110 to determine when the user device 110 is approaching the location of the merchant system 130 or is located at the merchant system 130. When approaching the location of the merchant system 130 or is in the location, the user device 110 can attempt to establish wireless communication with the merchant system 130. Additionally or alternatively, the user device 110 can recognize a wireless communication from the point of sale (“POS”) terminal of the merchant system 130 or other computing device of the merchant system 130 when approaching the location of the merchant system 130. The wireless communication can be a BLUETOOTH, near field communication, Wi-Fi, or other suitable communication signal. Any other signal or communication technology can be utilized to alert the user device 110 that the user 101 is at the location of the merchant system 130.

Upon establishing communication with the user device 110, the merchant system 130 and the user device 110 determine if the merchant system 130 has automatic payment status as described in block 215 and proceed to conduct the transaction omitting the authorization procedures as described in block 230.

In an alternative example embodiment, the user 101 completes an online purchase via the Internet. The user 101 can browse the merchant's website 136 for products using a web server 135 and indicate a desire to purchase one or more products. After the user 101 has indicated a desire to purchase the product(s) (for example, by actuating a “checkout” link), the merchant's website 136 can present a user interface in the form of a webpage to receive payment information from the user 101.

In another alternative example embodiment, the digital wallet application module 111 can interact with a merchant website 136 and with the user 101. The merchant's website 136 can detect whether the user device 110 includes a digital wallet application module 111 and attach to user's digital wallet application module 111. Once attached, the merchant's website 136 can send a purchase request message to the digital wallet application module 111 requesting payment information. In response to receiving a purchase request message from the merchant's website 136, the digital wallet application module 111 can present the user 101 with a user interface for the user 101 to confirm the purchase using payment information saved in the digital wallet application module 111.

The steps of establishing the online merchant system 130 an automatic payment recipient would be substantially similar to the steps describe in FIG. 2 and FIG. 3.

### Other Example Embodiments

Users may, in appropriate circumstances, limit or otherwise affect the operation of the features disclosed in the specification. For example, notice may be provided and/or consent may be obtained from users regarding collection or use of certain data or the activation of certain features. In addition, a user may change the manner in which the features are employed, including for situations in which a user may have concerns regarding his privacy. Instructions may be provided to notify the users regarding policies about the use of information, including personally identifiable information and receipt information, and manners in which the users may affect such use of information. Thus, information can be used to benefit a user, if desired, through receipt of relevant advertisements, offers, or other information, without risking disclosure of personal information or the user's identity.

Embodiments may comprise a computer program that embodies the functions described and illustrated herein, wherein the computer program is implemented in a computer system that comprises instructions stored in a machine-readable medium and a processor that executes the instructions. However, it should be apparent that there could be many different ways of implementing embodiments in computer programming, and the embodiments should not be construed as limited to any one set of computer program instructions. Further, a skilled programmer would be able to write such a computer program to implement an embodiment of the disclosed embodiments based on the appended flow charts and associated description in the application text. Therefore, disclosure of a particular set of program code instructions is not considered necessary for an adequate understanding of how to make and use embodiments. Further, those skilled in the art will appreciate that one or more aspects of embodiments described herein may be performed by hardware, software, or a combination thereof, as may be embodied in one or more computing systems. Moreover, any reference to an act being performed by a computer should not be construed as being performed by a single computer as more than one computer may perform the act.

The example embodiments described herein can be used with computer hardware and software that perform the methods and processing functions described previously. The systems, methods, and procedures described herein can be embodied in a programmable computer, computer-executable software, or digital circuitry. The software can be stored on computer-readable media. For example, computer-readable media can include a floppy disk, RAM, ROM, hard disk, removable media, flash memory, memory stick, optical media, magneto-optical media, CD-ROM, etc. Digital circuitry can include integrated circuits, gate arrays, building block logic, field programmable gate arrays (FPGA), etc.

The example systems, methods, and acts described in the embodiments presented previously are illustrative, and, in alternative embodiments, certain acts can be performed in a different order, in parallel with one another, omitted entirely, and/or combined between different example embodiments, and/or certain additional acts can be performed, without departing from the scope and spirit of various embodiments. Accordingly, such alternative embodiments are included in the inventions described herein.

Although specific embodiments have been described above in detail, the description is merely for purposes of illustration. It should be appreciated, therefore, that many aspects described above are not intended as required or essential elements unless explicitly stated otherwise. Modifications of, and equivalent components or acts corresponding to, the disclosed aspects of the example embodiments, in addition to those described above, can be made by a person of ordinary skill in the art, having the benefit of the present disclosure, without departing from the spirit and scope of embodiments defined in the following claims, the scope of which is to be accorded the broadest interpretation so as to encompass such modifications and equivalent structures.

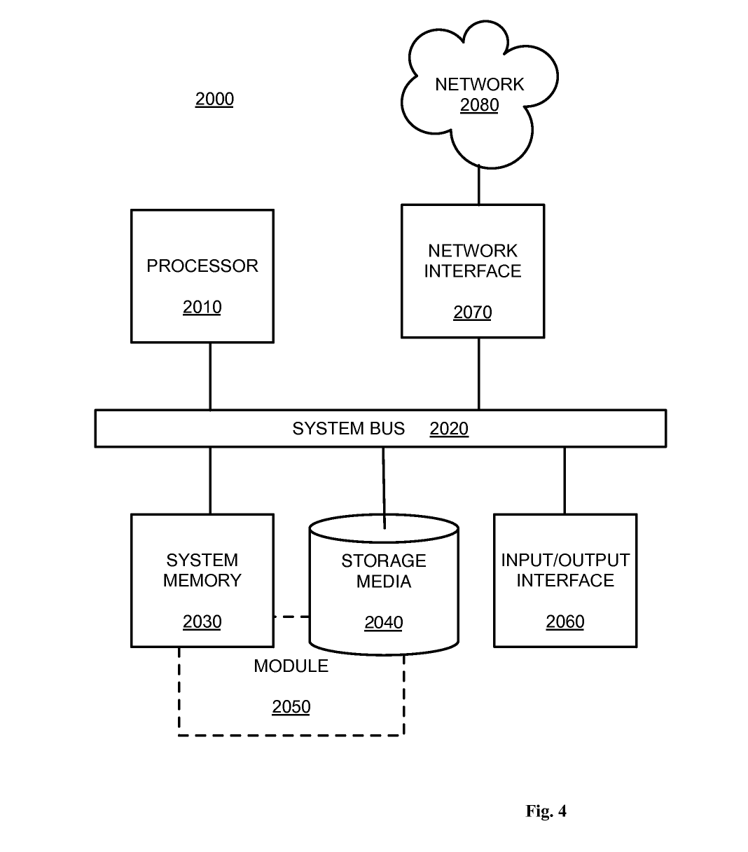

FIG. 4 depicts a computing machine 2000 and a module 2050 in accordance with certain example embodiments. The computing machine 2000 may correspond to any of the various computers, servers, mobile devices, embedded systems, or computing systems presented herein. The module 2050 may comprise one or more hardware or software elements configured to facilitate the computing machine 2000 in performing the various methods and processing functions presented herein. The computing machine 2000 may include various internal or attached components such as a processor 2010, system bus 2020, system memory 2030, storage media 2040, input/output interface 2060, and a network interface 2070 for communicating with a network 2080.

The computing machine 2000 may be implemented as a conventional computer system, an embedded controller, a laptop, a server, a mobile device, a smartphone, a set-top box, a kiosk, a vehicular information system, one more processors associated with a television, a customized machine, any other hardware platform, or any combination or multiplicity thereof. The computing machine 2000 may be a distributed system configured to function using multiple computing machines interconnected via a data network or bus system.

The processor 2010 may be configured to execute code or instructions to perform the operations and functionality described herein, manage request flow and address mappings, and to perform calculations and generate commands. The processor 2010 may be configured to monitor and control the operation of the components in the computing machine 2000. The processor 2010 may be a general purpose processor, a processor core, a multiprocessor, a reconfigurable processor, a microcontroller, a digital signal processor (“DSP”), an application specific integrated circuit (“ASIC”), a graphics processing unit (“GPU”), a field programmable gate array (“FPGA”), a programmable logic device (“PLD”), a controller, a state machine, gated logic, discrete hardware components, any other processing unit, or any combination or multiplicity thereof. The processor 2010 may be a single processing unit, multiple processing units, a single processing core, multiple processing cores, special purpose processing cores, co-processors, or any combination thereof. According to certain embodiments, the processor 2010 along with other components of the computing machine 2000 may be a virtualized computing machine executing within one or more other computing machines.

The system memory 2030 may include non-volatile memories such as read-only memory (“ROM”), programmable read-only memory (“PROM”), erasable programmable read-only memory (“EPROM”), flash memory, or any other device capable of storing program instructions or data with or without applied power. The system memory 2030 may also include volatile memories such as random access memory (“RAM”), static random access memory (“SRAM”), dynamic random access memory (“DRAM”), synchronous dynamic random access memory (“SDRAM”). Other types of RAM also may be used to implement the system memory 2030. The system memory 2030 may be implemented using a single memory module or multiple memory modules. While the system memory 2030 is depicted as being part of the computing machine 2000, one skilled in the art will recognize that the system memory 2030 may be separate from the computing machine 2000 without departing from the scope of the subject technology. It should also be appreciated that the system memory 2030 may include, or operate in conjunction with, a non-volatile storage device such as the storage media 2040.

The storage media 2040 may include a hard disk, a floppy disk, a compact disc read only memory (“CD-ROM”), a digital versatile disc (“DVD”), a Blu-ray disc, a magnetic tape, a flash memory, other non-volatile memory device, a solid sate drive (“SSD”), any magnetic storage device, any optical storage device, any electrical storage device, any semiconductor storage device, any physical-based storage device, any other data storage device, or any combination or multiplicity thereof. The storage media 2040 may store one or more operating systems, application programs and program modules such as module 2050, data, or any other information. The storage media 2040 may be part of, or connected to, the computing machine 2000. The storage media 2040 may also be part of one or more other computing machines that are in communication with the computing machine 2000 such as servers, database servers, cloud storage, network attached storage, and so forth.

The module 2050 may comprise one or more hardware or software elements configured to facilitate the computing machine 2000 with performing the various methods and processing functions presented herein. The module 2050 may include one or more sequences of instructions stored as software or firmware in association with the system memory 2030, the storage media 2040, or both. The storage media 2040 may therefore represent examples of machine or computer readable media on which instructions or code may be stored for execution by the processor 2010. Machine or computer readable media may generally refer to any medium or media used to provide instructions to the processor 2010. Such machine or computer readable media associated with the module 2050 may comprise a computer software product. It should be appreciated that a computer software product comprising the module 2050 may also be associated with one or more processes or methods for delivering the module 2050 to the computing machine 2000 via the network 2080, any signal-bearing medium, or any other communication or delivery technology. The module 2050 may also comprise hardware circuits or information for configuring hardware circuits such as microcode or configuration information for an FPGA or other PLD.

The input/output (“I/O”) interface 2060 may be configured to couple to one or more external devices, to receive data from the one or more external devices, and to send data to the one or more external devices. Such external devices along with the various internal devices may also be known as peripheral devices. The I/O interface 2060 may include both electrical and physical connections for operably coupling the various peripheral devices to the computing machine 2000 or the processor 2010. The I/O interface 2060 may be configured to communicate data, addresses, and control signals between the peripheral devices, the computing machine 2000, or the processor 2010. The I/O interface 2060 may be configured to implement any standard interface, such as small computer system interface (“SCSI”), serial-attached SCSI (“SAS”), fiber channel, peripheral component interconnect (“PCI”), PCI express (PCIe), serial bus, parallel bus, advanced technology attached (“ATA”), serial ATA (“SATA”), universal serial bus (“USB”), Thunderbolt, FireWire, various video buses, and the like. The I/O interface 2060 may be configured to implement only one interface or bus technology. Alternatively, the I/O interface 2060 may be configured to implement multiple interfaces or bus technologies. The I/O interface 2060 may be configured as part of, all of, or to operate in conjunction with, the system bus 2020. The I/O interface 2060 may include one or more buffers for buffering transmissions between one or more external devices, internal devices, the computing machine 2000, or the processor 2010.

The I/O interface 2060 may couple the computing machine 2000 to various input devices including mice, touch-screens, scanners, biometric readers, electronic digitizers, sensors, receivers, touchpads, trackballs, cameras, microphones, keyboards, any other pointing devices, or any combinations thereof. The I/O interface 2060 may couple the computing machine 2000 to various output devices including video displays, speakers, printers, projectors, tactile feedback devices, automation control, robotic components, actuators, motors, fans, solenoids, valves, pumps, transmitters, signal emitters, lights, and so forth.

The computing machine 2000 may operate in a networked environment using logical connections through the network interface 2070 to one or more other systems or computing machines across the network 2080. The network 2080 may include wide area networks (WAN), local area networks (LAN), intranets, the Internet, wireless access networks, wired networks, mobile networks, telephone networks, optical networks, or combinations thereof. The network 2080 may be packet switched, circuit switched, of any topology, and may use any communication protocol. Communication links within the network 2080 may involve various digital or an analog communication media such as fiber optic cables, free-space optics, waveguides, electrical conductors, wireless links, antennas, radio-frequency communications, and so forth.

The processor 2010 may be connected to the other elements of the computing machine 2000 or the various peripherals discussed herein through the system bus 2020. It should be appreciated that the system bus 2020 may be within the processor 2010, outside the processor 2010, or both. According to some embodiments, any of the processor 2010, the other elements of the computing machine 2000, or the various peripherals discussed herein may be integrated into a single device such as a system on chip (“SOC”), system on package (“SOP”), or ASIC device.

1. A computer-implemented method to reduce authorization levels required for transactions with merchants, comprising:
receiving, using one or more computing devices and from a user computing device associated with a user, a request for a first transaction with a merchant, the transaction request comprising information identifying an account of the user for payment of the first transaction and transaction data comprising information regarding the first transaction, the first transaction requiring a first authorization level;
identifying, using one or more computing devices, data on one or more previous transactions of the merchant;
determining, using one or more computing devices, that the merchant is a candidate to be a payment recipient requiring a reduced authorization level based at least in part on a comparison of the data on the one or more previous transactions of the merchant with a set of parameters;
communicating, using one or more computing devices and to the user computing device associated with the user, a notice of the determination;
receiving, using one or more computing devices and from the user computing device, an indication of an acceptance of the merchant as a payment recipient requiring a reduced authorization level;
establishing, using one or more computing devices, a reduced level of transaction authorization required for a subsequent transaction between the user and the merchant, the reduced level being less than the first level;
recognizing, using the one or more computing devices, that the user computing device is at a location of the merchant for a second transaction that is after the establishing step; and
configuring, using the one or more computing devices, the user network device to conduct the second transaction using the reduced level of transaction authorization.

2. The computer-implemented method of claim 1, the one or more previous transactions of the merchant comprising transactions between the merchant and the user.

3. The computer-implemented method of claim 1, the one or more previous transactions of the merchant further comprising the current transaction.

4. The computer-implemented method of claim 1, the determining step comprising:
establishing, using one or more computing devices, a threshold number of previous transactions between the user and the merchant; and
determining, using one or more computing devices, that the number of previous transactions between the user and the merchant exceeds the threshold.

5. The computer-implemented method of claim 4, further comprising:
identifying, using one or more computing devices, a value for each of the one or more previous transactions of the merchant; and
determining, using one or more computing devices, that an average of the values for the one or more previous transactions is within a predetermined range.

6. The computer-implemented method of claim 5, the average excluding any value that is a preconfigured amount greater than a median of the values for the one or more transactions.

7. The computer-implemented method of claim 1, the determining step comprising:
establishing, using one or more computing devices, a threshold number of customers that have accepted the merchant as a payment recipient requiring a reduced authorization level; and
determining, using one or more computing devices, that the number of customers that have accepted the merchant as a payment recipient requiring a reduced authorization level exceeds the threshold.

8. The computer-implemented method of claim 1, the determining step comprising:
establishing, using one or more computing devices, a threshold number of customers that have conducted a predetermined number of transactions with the merchant that are within a predetermined range of transaction values; and
determining, using one or more computing devices, that the number of customers that have conducted a predetermined number of transactions with the merchant that are within a predetermined range of transaction values exceed the threshold.

9. The computer-implemented method of claim 1, further comprising establishing, using one or more computing devices, a range of transaction values required for the first transaction to be conducted with a level less than the standard level.

10. A computer program product, comprising:
a non-transitory computer-readable storage device having computer-executable program instructions embodied thereon that when executed by a computer establish merchants as automatic payment recipients, the computer-readable program instructions comprising:
computer-executable program instructions to receive a request for a first transaction with a merchant, the transaction request comprising information identifying an account of the user for payment of the first transaction and transaction data comprising information regarding the first transaction, the first transaction requiring a first authorization level;
computer-executable program instructions to identify data on one or more previous transactions of the merchant;
computer-executable program instructions to determine that the merchant is a candidate to be a payment recipient requiring a reduced authorization level based at least in part on a comparison of the data on the one or more previous transactions of the merchant with a set of parameters;
computer-executable program instructions to communicate the determination;
computer-executable program instructions to receive an indication of an acceptance of the merchant as a payment recipient requiring a reduced authorization level; and
computer-executable program instructions to establish a reduced level of transaction authorization required for a subsequent transaction between the user and the merchant, the reduced level being less than the first level.

11. The program product of claim 10, further comprising:
computer-executable program instructions to recognize that the user computing device is at a location of the merchant for a second transaction that is after the establishing step;
computer-executable program instructions to configure the user network device to conduct the second transaction using the reduced level of transaction authorization.

12. The program product of claim 10, the one or more previous transactions of the merchant further comprising the current transaction.

13. The program product of claim 10, the determining step comprising:
computer-executable program instructions to establish a threshold number of transactions between the user and the merchant; and
computer-executable program instructions to determine that the number of transactions between the user and the merchant exceed the threshold.

14. The program product of claim 10, further comprising:
computer-executable program instructions to identify a value for each of the one or more previous transactions of the merchant; and
computer-executable program instructions to determine that an average of the values for the one or more previous transactions is within a predetermined range.

15. The program product of claim 10, the determining step comprising:
computer-executable program instructions to establish a threshold number of customers that have accepted the merchant as a payment recipient requiring a reduced authorization level; and
computer-executable program instructions to determine that the number of customers that have accepted the merchant as a payment recipient requiring a reduced authorization level exceeds the threshold.

16. A system to use a one-time code to establish merchants as automatic payment recipients, the system comprising:
a storage resource;
a network module; and
a processor communicatively coupled to the storage resource and the network module, wherein the processor executes application code instructions that are stored in the storage resource and that cause the system to:
receive a request for a first transaction with a merchant, the transaction request comprising information identifying an account of the user for payment of the first transaction and transaction data comprising information regarding the first transaction, the first transaction requiring a first authorization level;
identify data on one or more previous transactions of the merchant;
determine that the merchant is a candidate to be a payment recipient requiring a reduced authorization level based at least in part on a comparison of the data on the one or more previous transactions of the merchant with a set of parameters;
communicate a notice of the determination;
receive an indication of an acceptance of the merchant as a payment recipient requiring a reduced authorization level; and
establish a reduced level of transaction authorization required for a subsequent transaction between the user and the merchant, the reduced level being less than the first level.

17. The system of claim 16, further comprising instructions that cause the system to:
recognize that the user computing device is at a location of the merchant for a second transaction that is after the establishing step; and
configure the user network device to conduct the second transaction using the reduced level of transaction authorization.

18. The system of claim 16, the determining step comprising instructions that further cause the system to:
establish a threshold number of previous transactions between the user and the merchant; and
determine that the number of previous transactions between the user and the merchant exceeds the threshold.

19. The system of claim 16, further comprising instructions that cause the system to:
identify a value for each of the one or more previous transactions of the merchant; and
determine that an average of the values for the one or more previous transactions is within a predetermined range.

20. The system of claim 16, the determining step comprising instructions that further cause the system to:
establish a threshold number of customers that have accepted the merchant as a payment recipient requiring a reduced authorization level; and
determine that the number of customers that have accepted the merchant as a payment recipient requiring a reduced authorization level exceeds the threshold.
